(19) United States
(12) Patent Application Publication
(10) Pub. No.: US 2003/0097465 A1
(43) Pub. Date: May 22, 2003

(54) Internet access

(76) Inventors: Mark Alan West, Southampton (GB); Stephen McCann, Hampshire (GB); Robert Hancock, Hampshire (GB)

Correspondence Address: CROWELL & MORING LLP, INTELLECTUAL PROPERTY GROUP, P.O. BOX 14300, WASHINGTON, DC, 20044-4300, US

(21) Appl. No.: 10/149,974

(22) PCT Filed: Dec. 14, 2000
(86) PCT No.: PCT/GB00/04782

(30) Foreign Application Priority Data
Dec. 18, 1999 (GB) 9929880.4
Oct. 6, 2000 (GB) 0024459.0

(51) Int. Cl. G06F 15/173

(52) U.S. Cl. 709/238; 709/249

(57) ABSTRACT

Described herein is a method of providing an enhanced path between an internet or intranet (40) and a stub or further internet or intranet (36). The enhanced path is provided by locating a pair of associated enhancers (22, 32) such that one is located in the internet (40) and one is located in the stub network (36), the enhancers (22, 32) being connected together by means of an IP tunnel (50) and each knows the IP address of the other.

The present invention relates to improvements in or relating to internet or intranet access particularly through the use of internet protocol (IP) tunnels.

There may be circumstances where two internets need to exchange data and where it is desirable that the data packets pass through an IP (internet protocol) tunnel. The datagrams from a number of hosts are aggregated and transferred inside valid IP datagrams to the remote tunnel endpoint, at which point the data is passed to various end-systems. Such tunnelling systems may be implemented in such a way as to allow for potential performance enhancements to be realised, especially in the case of long latency links.

One way in which performance can be enhanced is by utilising connection splitting techniques. However, whilst such techniques provide performance enhancement, they have distinct problems from a processing load and security viewpoint.

From the processing load perspective, applying techniques such as data compression require significant computer resources. This is even truer when performing data encryption and secure user authentication. Additionally, an end-user will generally prefer to terminate or originate a secure link only in a network over which he has administrative control.

It is therefore an object of the present invention to provide a solution which overcomes the disadvantages mentioned above.

In accordance with one aspect of the present invention, there is provided a method of providing an enhanced path between first and second internets, the method comprising the steps of:

locating a first nested enhancer within the first internet;

locating a second nested enhancer within the second internet; and

establishing an association between the first and second nested enhancers.

Advantageously, the step of associating the first and second nested enhancers comprises providing each of the nested enhancers with the IP address of the other.

Preferably, the method further comprises the step of connecting together the first and second enhancers via an IP tunnel.

In one embodiment of the present invention, the IP tunnel includes a section that runs over a geostationary satellite link.

Additionally, pairs of enhancers may be nested such that the IP tunnel between a given pair of enhancers passes through any number of other, inner nested pairs. The IP tunnel between the outer pair may be passed transparently, tunnelled or enhanced by the inner pair(s).

The term ‘internet’ as used herein is intended to encompass both the worldwide web as well as local networks which may also be considered as internets.

For a better understanding of the present invention, reference will now be made, by way of example only, to the accompanying drawings in which:

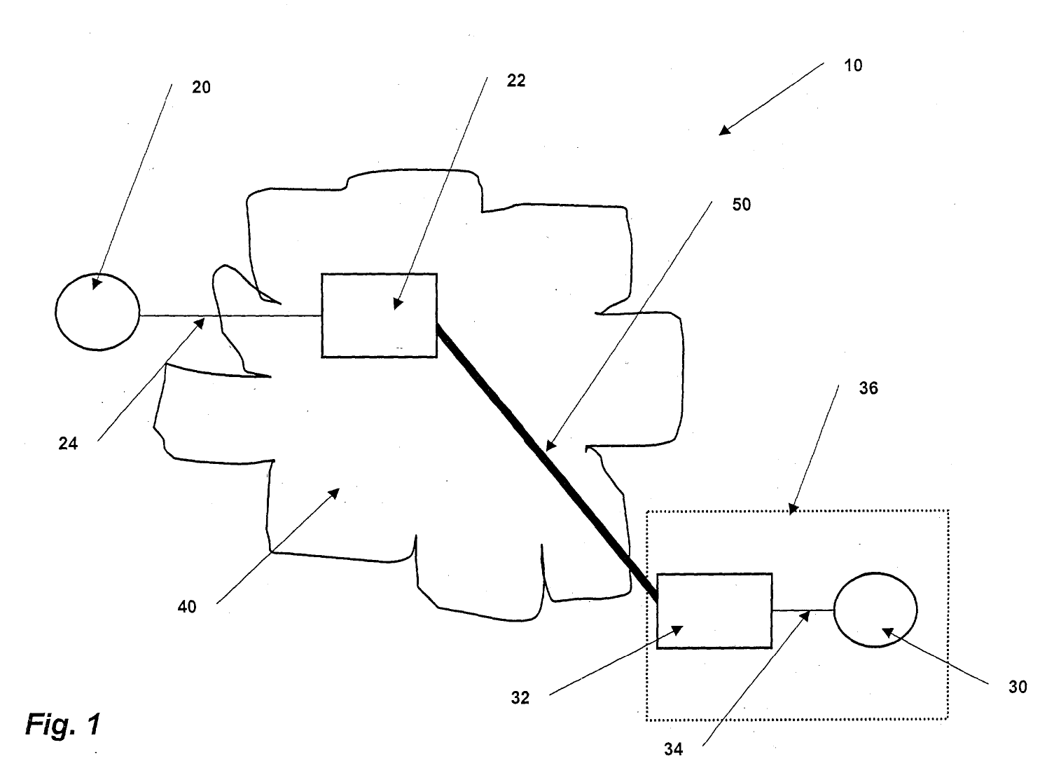

FIG. 1 illustrates the use of nested enhancer arrangement in accordance with the present invention; and

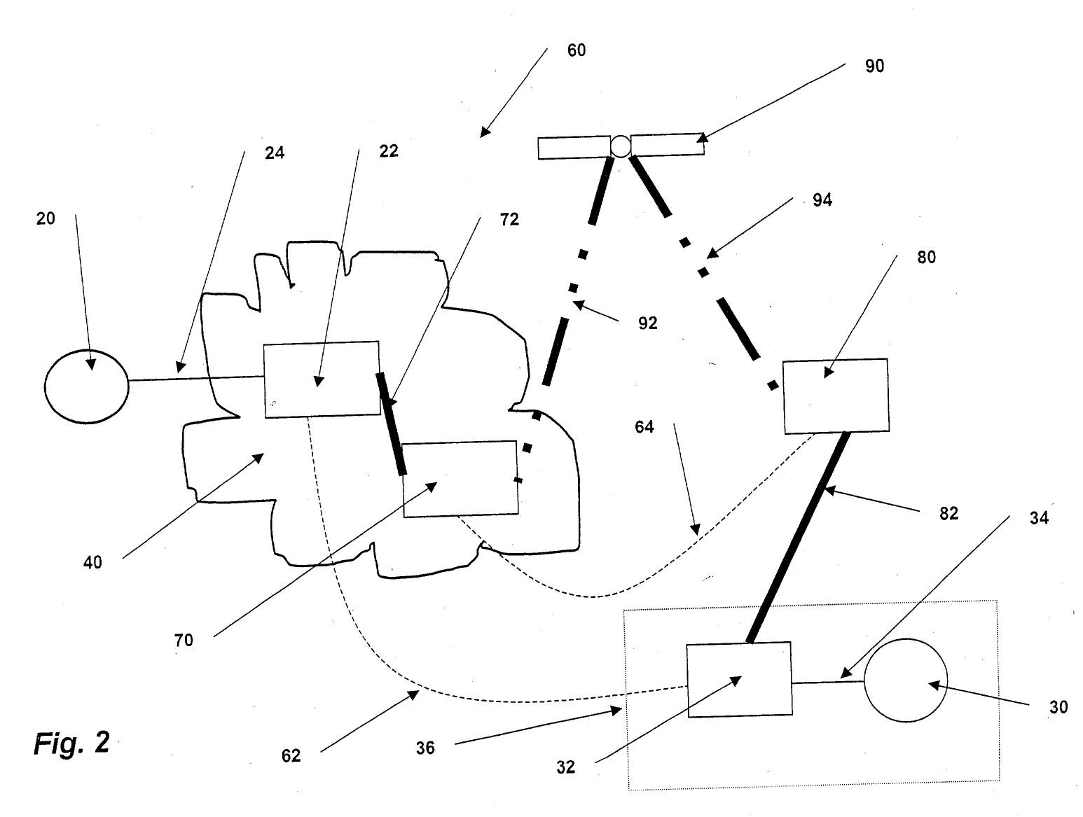

FIG. 2 illustrates the use of multiple nested enhancers in accordance with the present invention.

In FIG. 1, a nested enhancer arrangement 10 is shown which comprises a first host 20 which is to be connected to a second host 30 via an internet or intranet 40. The first host 20 is connected to a first enhancer 22 within the internet or intranet 40 via a logical link 24. The term ‘logical link’ as used herein means that a physical path needs to exist, but the path does not necessarily need to be a point-to-point path. Similarly, the second host 30 is connected to a second enhancer 32 via a link 34. The second enhancer 32 and the second host 30 form a stub network or further internet or intranet 36. The first and second enhancers 22, 32 are connected together by an IP (internet protocol) tunnel 50 as shown.

It will be appreciated that the first and second enhancers 22, 32 operate as a pair and make use of an IP route between the internet or intranet 40 and the stub network 36. As shown in FIG. 1, one nested enhancer 32 is located within the stub network 36 and its partner 22 is located somewhere in the internet or intranet 40 as a whole. It is not important where it is—only that each enhancer 22, 32 knows the IP address of the other. This provides the IP tunnel 50 as described above.

In operation, each nested enhancer terminates any transmission control protocol (TCP) connection that it receives, either from a stub network 36 or from an internet host 20, and responds to the originating host as if it were the ultimate end-system. This operates in a similar way to connection splitting as is well known in the art. The nested enhancer terminating the transmission then ‘tunnels’ data in the TCP connection to its partner, which regenerates the connection to the end-system. In this situation, it is preferable to link the pair of nested enhancers by a dedicated IP tunnel which conveniently operates over the existing IP network.

Advantageously, by applying a connection splitting technique, rather than simply encapsulating the original datagrams in the tunnel, scope is provided for performance enhancements, for example, connection set-up time to the end-system can be reduced. Using connection splitting also allows for per connection flow control to be easily managed by the tunnel end-points.

In the situation of long latency links, the use of the connection splitting can increase the throughput of individual sessions and improve link usage. The characteristics of intervening networks might result in benefits from this connection splitting approach.

The protocol must be capable of tunnelling all IP traffic from a nested enhancer back into an IP network to another nested enhancer, thus creating a IP tunnel between the two nested enhancers.

It is preferred to use TCP as the tunnelling protocol as it guarantees delivery of all tunnelled data from a local nested enhancer, for example, enhancer 22 to the distant nested enhancer 32 or vice versa. However, it will be appreciated that other suitable protocols can also be used. A multi-enhancer arrangement or network 60 is shown in FIG. 2 in which each pair of enhancers works independently of each other pair of enhancers, that is, each enhancer in each pair co-operates with the other enhancer of the pair but is independent of the other enhancers in the other pairs. Components which have previously been described bear the same reference numerals.

FIG. 2 shows a first host 20 connected to a second host 30 via an internet or intrantet 40 as before. The first host 20 is connected to a first enhancer 22 via a logical link 24, the first enhancer 22 being located somewhere in the internet or intranet 40. Similarly, the second host 30 is connected to a second enhancer 32 via a logical link 34 and together form a stub network 36. The first and second enhancers 22, 32 form a nested pair as described above as indicated by dotted line 62.

It will readily be understood that the stub network 36 may comprise another internet or intranet network as discussed above.

However, in this embodiment of the invention, the first and second enhancers 22, 32 can be thought of as being connected together by a single IP tunnel, but one which also passes through third and fourth enhancers 70, 80, the first enhancer 22 being connected to the third enhancer 70 in the internet or intranet 40 via IP tunnel portion 72 and the second enhancer 32 being connected to the fourth enhancer 80 via IP tunnel portion 82. Third and fourth enhancers 70, 80 form a nested pair as indicated by dotted line 64. The third enhancer 70 is connected to a geostationary satellite 90 via IP tunnel portion 92 and the fourth enhancer 80 is connected to the satellite 90 via IP tunnel portion 94.

It will readily be appreciated that the IP tunnel portions 92, 94 via satellite 90 form a single logical link. Moreover, IP tunnel portions 92, 94 may comprise the same IP tunnel portion with the satellite 90 acting as an RF relay.

It will be appreciated that IP tunnel portions 72, 92, 94 and 82 together form a single IP tunnel which is equivalent to the IP tunnel 50 shown in FIG. 1.

As the IP tunnel passes through the third and fourth enhancers 70, 80, this provides them with options, that is, they can transparently pass the IP tunnel through (i.e. do nothing), or they can carry the IP tunnel through what can be considered to be an inner tunnel optionally enhancing the data flow (where possible).

It will be apparent that the third and fourth enhancers 70, 80 form a nested pair which sit within the nested pair formed by the first and second enhancers 22, 32.

In order to avoid excessive load on the network 60, the IP tunnel portions 72, 82 between the third and fourth enhancers 70, 80 through which the data is tunnelled should ideally be ‘responsive’, that is, the connection must respond in the same way as a TCP connection does to perceived congestion and slow down in the network 60. For this reason, the obvious choice of protocol for the tunnel portions 72, 82 is a TCP/IP connection, although any suitable protocol, for example, Layer 2 Tunnelling Protocol—L2TP, could be used.

There are two important aspects to this tunnelling technique:

First, multiple pairs of nested enhancers can operate independently, for example, pair 22, 32 and pair 70, 80 in FIG. 2. This means that they can all apply data compression, for example. It is to be noted that, in order to maintain this independence, an enhancer should be able to identify traffic from another enhancer so that it knows not to perform duplicate processing on the connection. This could be done via reserved TCP port numbers, for example.

Secondly, security associations can be maintained between the nested enhancer pairs, and this provides a transparent means of securing communications between two end points.

A specific example of this is where the enhancers are each placed in stub networks or intranets, for example, in geographically diverse corporate offices. By deploying nested enhancers in each of the stub networks, all communications between the networks can be transparently encrypted and authenticated, and still be passed between the networks by normal IP routing methods. While this could be performed by any secure tunnel end point, normally the use of such equipment would preclude the use of other performance optimisations. By adding the security to the connection splitting unit, performance can be increased as well as maintaining a secure link.

The TCP connections on either side of the nested enhancers are isolated, so that, for example, a sequence of 500 byte packets entering the enhancer 22 from the first host 20, may appear as a sequence of 1 kbyte packets to the second host 30 although the total data transferred is the same. As data ordering does not change across the nested enhancer pairs, the second host 30 still perceives a single TCP/IP connection to the first host 20.

An important point for the use of nested enhancers is that once a data packet has reached the interface to the IP tunnel, the data is transferred to the distant host via an open IP link. The link is not opened and closed for each separate TCP session. Hence, apart from the initialisation stages of the tunnelling, a TCP session can utilise the full tunnel bandwidth and is not dependant upon slow start as would be the case in of end-to-end TCP session. The tunnel can be regarded as a free flowing dedicated virtual path between nested enhancers while retaining the ability to apply standard congestion avoidance and control techniques, for example, from the TCP family, to the IP tunnel.

1. A method of providing an enhanced path between first and second internets, the method comprising the steps of:
a first nested enhancer within the first internet;
locating a second nested enhancer within the second internet; and
establishing an association between the first and second nested enhancers.

2. A method according to claim 1, wherein the step of associating the first and second nested enhancers comprises providing each of the nested enhancers with the IP address of the other.

3. A method according to claim 1 or 2, further comprising the step of connecting together the first and second enhancers via an IP tunnel.

4. A method according to claim 3, wherein the IP tunnel includes a section that runs over a geostationary satellite.

5. A method according to claim 4, wherein pairs of enhancers may be nested such that the IP tunnel between a given pair of enhancers passes through any number of other inner, nested pairs.

6. A method according to claim 5, wherein the IP tunnel between the outer pair may be passed transparently, tunnelled or enhanced by the inner pair(s).

7. A method of providing an enhanced path between first and second internets substantially as hereinbefore described with reference to the accompanying drawings.
